(19) United States
(12) Patent Application Publication
(10) Pub. No.: US 2023/0368932 A1
(43) Pub. Date: Nov. 16, 2023

(54) FUEL STRUCTURES COMPRISING URANIUM DIOXIDE AND URANIUM DIBORIDE, AND RELATED FUEL ROD ASSEMBLIES AND METHODS

(71) Applicant: Battelle Energy Alliance, LLC, Idaho Falls, ID (US)

(72) Inventors: Adrian R. Wagner, Idaho Falls, ID (US); Jennifer K. Watkins, Idaho Falls, ID (US)

(21) Appl. No.: 17/663,307

(22) Filed: May 13, 2022

(51) Int. Cl. G21C 3/62; G21C 3/04; G21C 3/20

(52) U.S. Cl. CPC G21C 3/623; G21C 3/048; G21C 3/20

(57) ABSTRACT

A fuel structure includes an advanced technology fuel (ATF) composite body. The ATF composite body includes a first fissile material, such as uranium oxide (UO₂), and a second fissile material, such as uranium diboride (UB₂). The boron atoms of the second fissile material include an integrated burnable absorber (IBA). The ATF composite body further includes an ATF composition comprising the second fissile material combined with the first fissile material. The IBA of the second fissile material is distributed in a matrix of the first fissile material without a detectable amount of uranium tetraboride (UB₄).

### STATEMENT REGARDING FEDERALLY SPONSORED RESEARCH OR DEVELOPMENT

This invention was made with government support under Contract Number DE-AC07-05-1D14517 awarded by the United States Department of Energy. The government has certain rights in the invention.

### TECHNICAL FIELD

This disclosure relates generally to fuel structures. More particularly, embodiments of the disclosure relate to nuclear fuel structures including different fissile materials and an integrated burnable absorber (IBA) and related assemblies and methods.

### BACKGROUND

Nuclear reactors are used to generate power (e.g., electrical power) using nuclear fuel materials. For example, heat generated by nuclear reactions carried out within the nuclear fuel materials may be used to boil water, and the steam resulting from the boiling water may be used to rotate blades of a turbine. Rotation of a shaft driven by the turbine blades may be used to operate a generator for generating electrical power.

Nuclear reactors include what is referred to as a “nuclear core,” which is the portion of the nuclear reactor that includes the nuclear fuel material and is used to generate heat from the nuclear reactions of the nuclear fuel material. The nuclear core may include an array of fuel rods, which include the nuclear fuel material.

Most nuclear fuel materials include one or more of the radioactive elements of uranium and plutonium (although other elements such as thorium are also being investigated). There are, however, different types or forms of nuclear fuel materials that include such elements.

Nuclear fission reactors include heavy water reactors (HWRs) and light water reactors (LWRs). HWRs use deuterium oxide (D₂O) as a coolant/moderator. LWRs use water (H₂O) as the coolant/moderator. Generally, LWRs include pressurized water reactors (PWRs) and boiling water reactors (BWRs). Recently, advanced nuclear reactors are being developed to use additional cooling means, such as molten salt, liquid metal, and high temperature gases. These advanced nuclear reactors may include lead-fast reactors, fast-neutron reactors, space reactors, micro reactors, and small modular reactors (SMRs).

Despite improvements being made by advanced nuclear reactors, nuclear fuels are still highly radioactive, requiring extreme operational safety measures and precautions. Strict emergency procedures must be implemented in the event of disturbances including earthquakes, tsunamis, and other natural disasters. Furthermore, the small-scale design of some of the advanced nuclear reactors will require fuels with increased radioactive element density to improve fuel efficiency compared to fuels previously used in nuclear reactors.

Advanced Technology Fuels (ATFs) are being researched and developed to include burnable absorbers (BAs) to offset excess reactivity at the beginning of the life cycle of a nuclear fuel. However, the composition of traditional ATFs has emphasized the need for increased efficiency and thermal conductivity in fuel pellets to improve reactor behavior and economy.

Unfortunately, a conventional process used in fabrication of ATF fuel pellets is extremely complex. The current approach involves the use of Spark Plasma Sintering (SPS), flash sintering (FS), or Field-Assisted Sintering Techniques (FAST). Although the processes allow for very low sintering times, the use of SPS, FS, and FAST may require significant equipment and implementation costs, infrastructure overhaul, and reduced lifespan in pellets and fabrication equipment. Additionally, SPS, FS, or FAST manufacturing is limited in quantity and quality of samples produced per production cycle. For example, pellets produced through SPS may not be stable during operation due to the effects of the fabrication methodology. Although great strides have been made in the fabrication of ATF fuel pellets, significant challenges remain.

### BRIEF SUMMARY

In accordance with embodiments described herein, a fuel structure includes an Advanced Technology Fuel (ATF) composite body. The ATF composite body includes a first fissile material, such as uranium oxide (UO₂), and a second fissile material, such as uranium diboride (UB₂). The boron atoms of the second fissile material include an integrated burnable absorber (IBA). The ATF composite body further includes an ATF composition comprising the second fissile material combined with the first fissile material. The IBA of the second fissile material is distributed in a matrix of the first fissile material without a detectable amount of uranium tetraboride (UB₄).

In accordance with embodiments described herein, a fuel rod assembly comprises a pressurized housing, an array of fuel structures within the pressurized housing, and cladding material between the array of fuel structures and the pressurized housing. One or more fuel structures of the array of fuel structures comprise an ATF composite body. The ATF composite body includes a first fissile material and a second fissile material. The second fissile material includes uranium atoms, boron atoms, and one or more additives distributed with the second fissile material throughout a matrix of the first fissile material. The ATF composite body of the one or more fuel structures of the array of fuel structures does not have a detectable UB₄ phase.

In further embodiments described herein, a method of forming a fuel structure, comprises: selecting a first fissile material including uranium oxide; selecting a second fissile material including uranium boride, boron atoms of the second fissile material comprising an integrated burnable absorber (IBA), the boron atoms combined with uranium atoms comprising an initial IBA composition; adjusting an amount of the boron atoms of the initial IBA composition to form a second IBA composition; forming a preliminary fuel structure from the second IBA composition; combining the first fissile material and the second fissile material to form an ATF composition; and applying heat through one or more heat transfer processes to the ATF composition to obtain a nuclear fuel structure having an IBA distributed throughout a crystalline matrix of the first fissile material without a detectable amount of uranium tetraboride (UB₄).

### BRIEF DESCRIPTION OF THE DRAWINGS

FIG. 1 is a simplified perspective view of a fuel structure, in accordance with embodiments of the disclosure.

FIG. 2A is a perspective, cut-away view of a fuel rod housing including one or more fuel structures, in accordance with embodiments of the disclosure.

FIG. 2B is a perspective, partially deconstructed assembly view of the fuel rod housing of FIG. 2A.

FIG. 3 is a simplified block diagram of an energy system, in accordance with embodiments of the disclosure.

FIG. 4 is a simplified flow diagram of a method of forming a fuel structure, in accordance with embodiments of the disclosure.

FIG. 5 is a detailed flow diagram of a method of forming a fuel structure, in accordance with embodiments of the disclosure.

FIG. 6 is a phase diagram of a uranium-boron (U—B) system, in accordance with embodiments of the disclosure.

FIGS. 7A through 8B are backscatter electron (BSE) images of the results described in Example 2.

### DETAILED DESCRIPTION

Methods of forming a fuel structure, such as a nuclear fuel structure, are described, as are related fuel structures, energy systems, and fuel rod assemblies (e.g., pressurized containment vessels, pressurized fuel rod housings, reactor cores, etc.). In some embodiments, a method of forming the fuel structure comprises forming an Advanced Technology Fuel (ATF) composition formed of and including at least two fissile materials, and optionally, at least one additive (e.g., release agent). A portion of the ATF composition (e.g., an IBA composition, described below) may undergo at least a first heat transfer process (e.g., arc-melting, annealing, etc.), to form a preliminary fuel structure, and then the preliminary fuel structure may undergo a second heat transfer process (e.g., sintering, etc.) to interconnect the IBA within a matrix of the first fissile material and to form the fuel structure. The fuel structure may exhibit a desired internal structure and one or more desired micro-scale characteristics (e.g., density, thermal diffusivity, thermal conductivity, etc.). The types and amounts of the fissile materials and additive(s) (if any) of the ATF composition may be selected relative to each other to at least provide the ATF composition a different internal structure, density, and/or thermal conductivity than each of the different fissile materials alone, as well as to provide the subsequently formed fuel structure with the desired micro-scale characteristics.

The fuel structure (e.g., a composite fuel structure) of the disclosure may exhibit material properties that are more favorable to the use of the fuel structure in assemblies (e.g., fuel rod housing assemblies) for nuclear energy applications compared to material properties of fuel structures conventionally used in nuclear reactors. The fuel structure may, for example, exhibit increased thermal conductivity, density, and fissile material (e.g., uranium) loading compared to fuel structures formed through conventional methods. By selecting a first fissile material and a second fissile material such that both include uranium atoms, the fuel structures may have higher uranium loading. The fuel structures and assemblies formed in accordance with the methods of the disclosure may exhibit enhanced capabilities, performance, durability, and reliability as compared to fuel structures formed through conventional methods. Fuel structures formed in accordance with the methods of the disclosure may use existing infrastructure (e.g., traditional sintering furnaces and/or systems), and may be formed without the use of SPS, FS, or FAST processes, which have low production rates. Fuel structures and assemblies formed in accordance with the methods of the disclosure may decrease peak fuel and cladding temperatures under normal operation and in accident scenarios, improving safety margins and improved operational economy.

The illustrations presented herein are not actual views of any fuel structure, fuel rod, energy system, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any fuel structure. Furthermore, these terms may refer to an orientation of elements of any energy system as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the term “fissile material” refers to a low-grade, enriched fissionable material with its nuclide fissionable by thermal neutrons. The term “low-grade” means an enrichment level below that utilized in nuclear weapons, such as a low-enriched uranium (LEU) that comprises about 3% to about 5% of the fissile isotope, uranium-235. In some embodiments, the combination of fissile materials used in fuel structures facilitates the use of an LEU that comprises about 2% to about 4% of the fissile isotope, uranium-235. These embodiments represent reductions in the enrichment amount of the fissile isotope, uranium-235, relative to baseline fissile isotope enrichment levels, and are encompassed in the term.

As used herein, the term “solvus line” or a “solvus surface” is a feature of a phase diagram that differentiates between a fully homogeneous system and a structure where one species dominates the crystal structure, with the other as only a minority contaminant.

Embodiments of fuel structures disclosed herein comprise a nuclear fuel having increased uranium density. Embodiments of fabrication methods for making the fuel structures utilize a production method that accounts for volatilization of volatile materials (e.g., burnable absorbers) used in making ATF composite fuel structures.

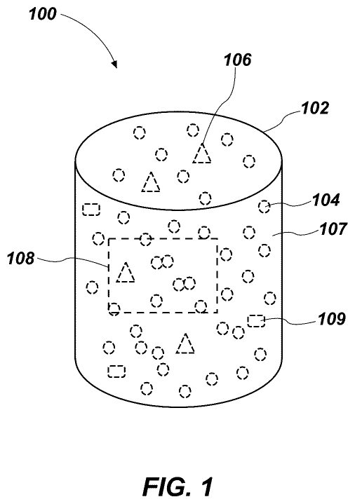

Referring to FIG. 1, a nuclear fuel structure 100 includes an Advanced Technology Fuel (ATF) composite body 102, a first fissile material 104, and a second fissile material 106, the first fissile material 104 exhibiting a different chemical composition from the second fissile material 106 as described in detail below. The nuclear fuel structure 100 further includes an external structure 107, such as a predetermined shape, and an internal structure 108, such as a desired grain or crystalline structure/size. The nuclear fuel structure 100 may also include one or more additives 109.

The combination of the first fissile material 104 and the second fissile material 106 may achieve one or more desired internal structures 108 and one or more micro-scale characteristics (e.g., density, thermal diffusivity, thermal conductivity, etc.) relative to the ATF composite body 102.

The combination of the first fissile material 104 and the second fissile material 106 may result in a homogeneous mixture distribution, or a uniform distribution of the second fissile material 106 relative to the first fissile material 104 throughout the entirety, or a majority (e.g., greater than 50% of volume), of the fuel structure 100 as formed. Alternatively, the combination of the first fissile material 104 and the second fissile material 106 may result in a heterogeneous mixture, or a substantially non-uniform distribution of the second fissile material 106 relative to the first fissile material 104 in specific, localized portions (e.g., facial surfaces) of the fuel structure 100. In some embodiments, the first fissile material 104, the second fissile material 106, and the one or more additives 109 may result in a homogeneous mixture, or a substantially uniform distribution of the one or more additives 109 and the second fissile material 106 relative to the first fissile material 104 throughout the entirety, or a majority (e.g., greater than 50% of volume), of the fuel structure 100 as formed. In other embodiments, the first fissile material 104, the second fissile material 106, and the one or more additives 109 may result in a heterogeneous mixture, or a substantially random distribution of the second fissile material 106 and the one or more additives 109 throughout the matrix of the first fissile material 104.

The nuclear fuel structure 100 may be formed from a preliminary fuel structure having an intermediary crystalline structure and comprising the second fissile material 106. For example, the nuclear fuel structure 100 may not obtain the internal structure 108 and the one or more desired micro-scale characteristics until it has been subjected to at least two heat transfer processes. The preliminary fuel structure may have an intermediary crystalline structure that is similar to the crystalline structure of the nuclear fuel structure 100 due to first heat transfer conditions. However, the preliminary fuel structure may exhibit different intermolecular (e.g., thermal conductivity), microstructural (e.g., density, grain size, etc.), or external (e.g., shape) characteristics as compared to the nuclear fuel structure 100 due to having experienced the single heat transfer process. In other words, although the preliminary fuel structure may exhibit some crystalline properties, the internal structure 108 and the one or more desired micro-scale characteristics of the nuclear fuel structure 100 may be obtained from exposing the first fissile material 104 and deconstructed components of the preliminary fuel structure (i.e., the second fissile material 106) to both the first heat transfer process (e.g., arc-melting) and a final heat transfer process (e.g., sintering). Following the at least two heat transfer processes, the second fissile material 106 is fused within a matrix of the first fissile material 104.

In some embodiments, the nuclear fuel structure 100 may be a “once-through” fuel structure. In other embodiments, the nuclear fuel structure 100 may be a fuel structure designed for recycling (e.g., for enhanced actinide utilization).

The relative quantities (e.g., amount, weight %, etc.) and types of the first fissile material 104, the second fissile material 106, and the one or more additives 109, if present, may be selected, tailored, increased, and/or decreased before, or between, heat transfer cycles to provide the desired internal structure 108 and the desired micro-scale characteristics. For example, the quantity and type of the different fissile materials 104, 106 may be selected to provide a desired density, thermal diffusivity, thermal conductivity, porosity, and/or particle distribution to the ATF composite body 102. By way of a non-limiting example, at least in embodiments wherein the nuclear fuel structure 100 is used as a component (e.g., fuel pellet) of a reactor core of a nuclear energy system, the quantity and type of the fissile materials 104, 106 may be selected relative to one another to tailor the density of the composite body 102 to a desired value ranging from about 9 g/cm³ to about 12 g/cm³, at operational temperatures ranging from 50° C. to 1000° C., and to tailor the thermal conductivity of the nuclear fuel structure 100 to a desired heat capacity, Cₚ, value ranging from about 0.20 J/g-K to about 0.50 J/g-K at the operational temperatures ranging from 50° C. to 1000° C.

The different fissile materials 104, 106 may be present in amounts relative to each other that achieve at least the desired internal structure 108, density, or thermal conductivity of the subsequently formed fuel structure 100. For example, the first fissile material 104 may be present in the nuclear fuel structure 100 at from about 50% by weight to about 95% by weight and the second fissile material 106 may be present in the nuclear fuel structure 100 at from about 5% by weight to about 50% by weight. In some embodiments, the first fissile material 104 is present in the nuclear fuel structure 100 at about 90% by weight and the second fissile material is present at about 10% by weight. Although the first fissile material 104 and the second fissile material 106 may be combined at about a 90:10 wt % ratio, in some embodiments, the nuclear fuel structure 100 (e.g., formed after the final heat transfer process, described below) may have a composite body 102 including less than about 90 wt % UO₂ and less than about 10 wt % UB₂ due to the presence of the one or more additives 109, volatilization, and other effects of the production process, but still greater than about 85 wt % to about 89 wt % UO₂ and greater than about 5 wt % to about 9 wt % UB₂ in total material composition.

The first fissile material 104 may include one or more compounds formulated to undergo nuclear fission, such as a uranium oxide (UₓO_{y}). With respect to the foregoing chemical formula, x-, y-, and z- are any stoichiometric values or are any non-stoichiometric values (e.g., not whole numbers, such as 0.1, 0.2, 0.3, etc.). In some embodiments, the first fissile material 104 includes uranium dioxide (UO₂).

A density of the first fissile material 104 may range from about nine (9) grams of fissile material per cm³ to about 11 grams of fissile material per cm³. In some embodiments, the first fissile material 104 may exhibit a fissile material density ranging from about nine (9) grams of fissile material per cm³ to about 10 grams of fissile material per cm³.

The first fissile material 104 may exhibit a desired particle size prior to undergoing the heat transfer processes. The particles may range from about submicron up to about 40 microns in diameter. In some embodiments, an average particle size according to a bimodal distribution of the first fissile material 104 prior to the heat transfer processes includes particles that may range from about two (2) microns in diameter up to about 37 microns in diameter (e.g., according to an average of a bimodal distribution). In other embodiments, the first fissile material 104 particles may range from about five (5) microns to about 25 microns in diameter. In additional embodiments the first fissile material 104 particles may range from about seven (7) microns to about 20 microns in diameter, according to an average of a bimodal distribution.

The second fissile material 106 may include one or more compounds formulated to undergo nuclear fission, and simultaneously function as a burnable poison, resonance absorber, or integrated burnable absorber (IBA) composition, such as a uranium compound that includes boron atoms (e.g., uranium diboride). To increase uranium loading in the composite body 102, the second fissile material 106 may include uranium atoms, and to increase the burnable poison function, the second fissile material 106 may include boron atoms. For example, the second fissile material 106 may comprise a uranium boride compound, such as uranium diboride (UB₂), uranium triboride (UB₃), uranium tetraboride (UB₄), or uranium dodecaboride (e.g., UB₁₂). In some embodiments, the second fissile material 106 may comprise uranium diboride (UB₂). In other embodiments, the second fissile material 106 may include nitrogen or carbon atoms.

Baseline IBA compositions of the second fissile material 106 (e.g., prior to a heat transfer process) may include atomic percentages of boron relative to uranium of greater than or equal to about 67%. In some embodiments, the second fissile material 106 includes a uranium diboride (UB₂) compound having an atomic percentage of boron of about 67.1% to about 67.4%. In other embodiments, the second fissile material 106 includes a uranium diboride (UB₂) compound having an atomic percentage of boron of about 67.2%. The UB₂ compound may be selected as the second fissile material 106 due to a relatively high thermal conductivity (e.g., ˜16 W/m·K at 300° C. for UB₂ relative to ˜7 W/m·K at 300° C. for UO₂), high uranium density (e.g., ˜11.7 grams/cm³, for UB₂ relative to ˜9.7 grams/cm³ for UO₂), and a high melting temperature (e.g., ˜2658 K for UB₂ relative to ˜3113 K for UO₂).

In some embodiments, conditions for forming the second fissile material 106 may be adjusted such that the UB₂ compound remains at, or is very near, the solvus line or the solvus surface of a binary or ternary uranium-boron system after heat transfer. In other words, a baseline uranium-boron compound may be formulated as an initial IBA composition, however a second IBA composition, or the IBA composition used during heat transfer, may include additional boron atoms, such that the U—B compound is moved away from the solvus line—just before heat transfer—and after heat transfer, the loss of boron atoms due to volatilization moves the compound back to the solvus line or solvus surface. For example, a baseline U—B compound may include one or more of UB₂, UB₄, and UB₁₂ as components of the U—B system. The properties and elemental amounts governing this system may be adjusted by adding boron atoms just prior to conducting heat transfer, such that the U—B compound temporarily includes at least two components (e.g., UB₂ and UB₄) of the U—B system. This adjustment may occur to account for subsequent heat transfer effects. After experiencing the heat transfer effects, a final fuel structure 100 may include substantially only one component (e.g., UB₂) of the U—B system, or at least does not include UB₄ in a detectable amount (i.e., UB₄ is not included in any amount that can be detected by a Malvern Panalytical Aeris X-ray Diffractometer—Cu K_{α}, 40 kV, 15 mA, step-size 0.011 2θ).

In some embodiments, the increase in uranium loading due to the use of two different fissile materials containing uranium allows for the use of a reduced enrichment level of ²³⁵U. For example, the LEU may comprise from about 2% to about 4% of the fissile isotope, uranium-235. In other words, the enrichment level of ²³⁵U may decrease by from about 1% to about 2%, relative to baseline enrichment levels of uranium, due to the increase in uranium atoms resulting from the combination of the first fissile material 104 and the second fissile material 106.

In some embodiments, the neutronics as determined by isotopes of the IBA, may be selectively tailored based on desirable characteristics of the isotopes. By adjusting the boron isotope ratio in the second fissile material 106, different properties of the nuclear fuel structure 100, such as thermal neutron absorption cross section, may be achieved. Without being bound by theory, due to a large neutron cross-section (e.g., microscopic, σ) of the boron-10 (¹⁰B) relative to a small neutron cross-section of the boron-11 (¹¹B) isotope, UB₂ may function as a burnable poison. For example, a neutron cross-section of a nuclear fuel structure 100, including UB₂ with an enriched ¹⁰B₂ isotope, is about 3840 barns, while a neutron cross section of the ¹¹B isotope within the nuclear fuel structure 100 is about five (5) milli-barns. This property of relative cross-sections provides a burnable poison (i.e., IBA) quality to the nuclear fuel structure 100. Accordingly, in some embodiments, the second fissile material 106 is enriched to contain a higher percentage of the ¹⁰B isotope, by mass, than the natural, elemental form of boron (i.e., which contains about 20% of the ¹⁰B isotope). In other embodiments, the second fissile material 106 is enriched to contain a higher percentage of the ¹¹B isotope, by mass, than the natural, elemental form of boron (i.e., which contains about 80% of the ¹¹B isotope). The selective tailoring of the neutronics, or boron isotope quantities, may vary based on a number of factors, including but not limited to initial neutronics of a fissile material, a desired internal structure 108 (e.g., first portion of internal structure to exhibit a simple fuel quality, while a second portion of the internal structure to exhibit an IBA quality), a life cycle of the nuclear system, a life cycle of surrounding fuel rods, a life cycle of the fuel rod assembly 110, a lifespan of the nuclear fuel structure 100, a lifespan of other surrounding nuclear fuel structures, a desired effect (e.g., burnable poison, neutron absorber, etc.), and combinations thereof.

The adjusting of the isotopes and relative ratios may occur through one or more enrichment processes. The enriched second fissile material 106 may have a specific isotope ratio that is selected to achieve one or more internal structures 108, such as a tailored neutron cross-section. For example, a portion of the ATF composite body 102 may include a different isotope enrichment level relative to another portion of the ATF composite body 102 to facilitate internal structure 108 that has varying isotope concentrations relative to different portions of the composite body 102. By way of another example, the one or more internal structures 108 may exhibit a gradient isotope concentration, such that either the ¹¹B isotope or the ¹⁰B isotope has a higher concentration at a first point, then gradually decreases moving to a second point within the one or more internal structures 108. Accordingly, an enriched form of boron may include the ¹¹B isotope ranging from about 30% to about 90% by mass and from about 10% to about 70% of the ¹⁰B isotope by mass.

In some embodiments, since the ¹⁰B isotope is a thermal neutron absorber, and the ¹¹B isotope is not, the ¹⁰B isotope may be increased relative to the ¹¹B isotope, creating a threshold amount or a threshold ratio of the ¹⁰B isotope relative to the ¹¹B isotope by mass. For example, the threshold amount of isotopes of the second fissile material 106 may comprise about 75% of the ¹¹B isotope and about 25% of the ¹⁰B isotope (e.g., threshold ratio of 3:1); or, the threshold amount of isotopes of the second fissile material 106 may comprise about 70% of the ¹¹B isotope and about 30% of the ¹⁰B isotope (e.g., threshold ratio of about 2.3:1). In some embodiments, the uranium diboride may comprise about 80% of the ¹¹B isotope and about 20% of the ¹⁰B isotope by mass.

The isotope enrichment, discussed above relative to the second fissile material 106, may be obtained through an Exchange Distillation Process (EDP), an Ion Displacement Chromatography Process (IDCP), or other similar enrichment processes.

The second fissile material 106 may exhibit a fissile material density ranging from about 10 grams of fissile material per cm³ to about 13 grams of fissile material per cm³. In some embodiments, the second fissile material 106 may exhibit a fissile material density ranging from about 11 grams of fissile material per cm³ to about 12 grams of fissile material per cm³.

The second fissile material 106 may exhibit a desired particle size prior to undergoing a heat transfer process. The particles may range from about submicron up to about 40 microns in diameter. In some embodiments, a particle size distribution of the second fissile material 106 prior to the heat transfer process includes particles that may range from about one (1) micron in diameter up to about 37 microns in diameter (e.g., according to an average of a bimodal distribution). In other embodiments, an average particle size of the second fissile material 106 prior to the heat transfer process, according to a bimodal distribution, may range from about one (1) micron in diameter up to about eight (8) microns in diameter. In other embodiments, the bimodal average particle size of the second fissile material 106 particles may be about two (2) microns to about five (5) microns in diameter.

In some embodiments, the second fissile material 106 may be uniformly or randomly distributed throughout the composite body 102. Accordingly, the nuclear fuel structure 100 may be substantially homogenous, or heterogeneous in material composition, depending at least on whether the uniform or random distribution is obtained relative to the second fissile material 106.

The external structure 107 of the nuclear fuel structure 100 may include the composite body 102 configured as a right-cylindrical shape, an hourglass shape, “barbell” shapes, square, spherical, hemispherical, cubic, cuboidal, rectangular, trapezoidal, pyramidal, annular, slotted, tetrahedron, ellipsoidal, helical, truncated versions thereof, such as, for example, frusto-conical, semi-helical, or an irregular shape, such as a shape having surfaces with concave impressions (e.g., at axial ends of the composite body), surfaces with convex protrusions, polygonal surfaces, and combinations thereof. Surfaces of a shape may be fully chamfered, partially chamfered, beveled chamfering, straight edges (e.g., with no chamfering), and combinations thereof. In some embodiments, the external structure 107 may exhibit a right-cylindrical shape, an annular shape, or a combination thereof. In some embodiments, the composite body 102 may comprise a substantially rigid shape, such as in a fuel pellet form. In other embodiments, the external structure 107 of the composite body 102 may be less rigid, such as a powder form (e.g., where sidewalls of a container or a powder delivery nozzle provide a shape to the composite body 102).

The internal structure 108 of the nuclear fuel structure 100 may comprise the second fissile material 106 and the one or more additives 109 distributed throughout a matrix of the first fissile material 104. The matrix of the first fissile material 104 may include one or more lattices (e.g., hexagonal, cubic, or tetragonal) or crystalline structures formed from specific compositions (e.g., oxides) and specific conditions (e.g., high-temperature heat transfer). In some embodiments, ceramic or crystalline matrix of the internal structure 108 includes individual lattice structures or crystalline structures, such as rod-like formations, flat faces, whiskers, and/or substantially symmetric configurations, resulting from a final heat transfer process (e.g., sintering). The internal structure 108 may comprise crystallographic properties, such as an average grain size ranging from about 0.5 microns to about 3.5 microns. In some embodiments, the mean grain size ranges from about 1.9 microns to about 2.7 microns and the median grain size ranges from about 1.1 microns to about 1.6 microns.

The one or more desired micro-scale characteristics of the composite body 102 may include, but are not limited to, microstructural and/or intermolecular properties, such as: a density ranging from 10 to 12 g/cm³, which is approximately 90% to 98% of the theoretical densities from a baseline starting composition (e.g., by weight); an increase in thermal diffusivity of from approximately 20% to approximately 50% over baseline values for UO₂ (e.g., at temperatures ranging from 50° C. to 1000° C.); specific heat capacity values, Cₚ, ranging from about 0.20 J/g-K (or J/g-° C.) to about 0.50 J/g-K (or J/g-° C.); and, an increase in thermal conductivity of from about 50% to about 99% relative to baseline UO₂ values (e.g., at temperatures ranging from 50° C. to 1000° C.). In some embodiments, the density of the composite body 102 ranges from about 10.6 to about 10.8 gm/cm³ (e.g., greater than about 94% of the theoretical density), the increase in thermal diffusivity ranges from about 30% to about 40%, the average grain size ranges from about 0.9 microns to about 2.9 microns, the specific heat capacity ranges from about 0.26 J/g-K to about 0.44 J/g-K, and the increase in thermal conductivity ranges from about 62% to about 93% relative to the baseline values. In other embodiments, the increase in thermal diffusivity is measured relative to SPS sintered samples, and ranges from about 5% to about 10% or higher thermal diffusivity than the SPS sintered samples.

The one or more additives 109 may include, but are not limited to, a releasing agent (e.g., zinc stearate, ethylene bis (stearamide), zirconium oxide, etc.), such as to release the fuel structure from a sintering mold, a structural enhancer (e.g., dopant for increasing a tensile strength), neutron reflector (e.g., beryllium, graphite, etc.), fission barrier material (e.g., zirconium, vanadium, zirconium boride (ZrB₂), etc.), refractory metal (e.g., molybdenum, tungsten, vanadium, tantalum, chromium, hafnium, rhenium, titanium), refractory metal oxide (e.g., titanium oxide, zirconium oxide, etc.), a recycled actinide from a spent nuclear fuel (e.g., neptunium, americium, or curium obtained through transmutation), a fuel-cladding chemical interaction (FCCI) reducer (e.g., tin and/or palladium), a stabilizer (e.g., yttrium oxide), a rare-earth element (e.g., lanthanum, cerium, praseodymium, or neodymium), a neutron absorber, and combinations thereof. The one or more additives 109 used in the fuel structure 100 may depend at least on the materials and quantities of the first fissile material 104 and the second fissile material 106 within the ATF composite body 102. The one or more additives make up about 0.01 wt % to about 0.1 wt % of the total composition of the nuclear fuel structure 100. In some embodiments, the one or more additives make up about 0.02 wt % of the nuclear fuel structure 100.

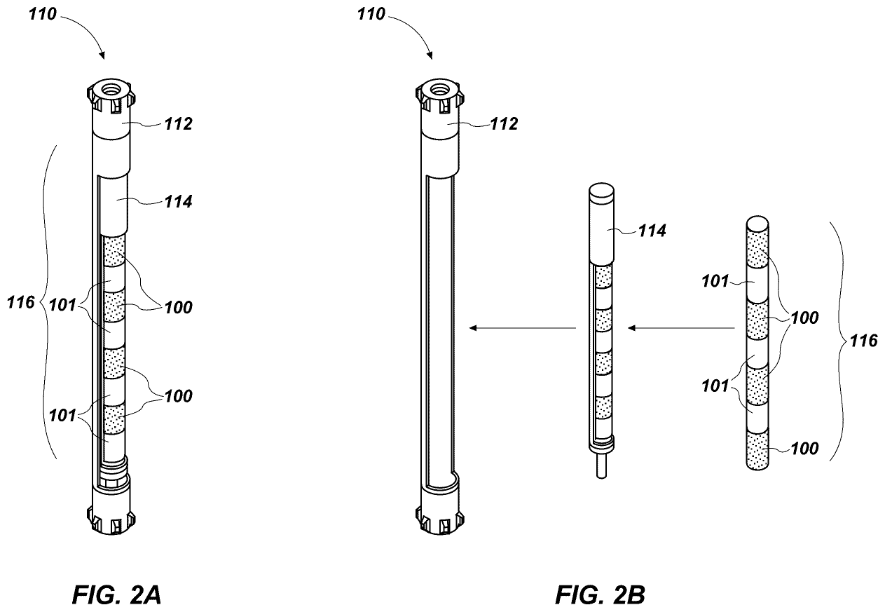

Referring to FIG. 2A, a fuel rod assembly 110 includes a pressurized fuel rod housing 112, a fuel structure cladding material 114, at least one nuclear fuel structure 100, and at least one fuel structure 101. The at least one fuel structure 101 is similar to the at least one fuel structure 100, except the at least one fuel structure 101 may not include an IBA or an IBA composition. In some embodiments, the nuclear fuel structure 100 may comprise less than a majority of the fuel structures of an array 116 of fuel structures housed within the pressurized fuel rod housing 112. In other embodiments, the array 116 of fuel structures includes the at least one fuel structure 101, and which make up less than or equal to a majority of the fuel structures in the array 116 of fuel structures.

The cladding material 114 may include zirconium, vanadium, stainless steel, (e.g., alloy of chromium and nickel, or an alloy of chromium, nickel, ferric steel, molybdenum, copper, and/or vanadium), a nickel alloy, an aluminum alloy, an iron alloy, a zirconium alloy (e.g., zircaloy), an iron-chromium-aluminum (FeₓCr_{y}Al) alloy (e.g., oxide dispersion strengthened (ODS) FeₓCr_{y}Al alloy), a silicon carbide (SiC) continuous fiber-reinforced SiC matrix, or combinations thereof. In some embodiments, the cladding material 114 is neutron absorbing, and in other embodiments the cladding material 114 is neutron transparent.

The cladding material 114 may fully or partially encompass the fuel structures in the array 116 of fuel structures. The cladding material 114 may be directly adjacent one or more fuel structures (e.g., fuel structure 100), or the cladding material 114 may be directly adjacent a gap or void that is between the cladding material 114 and the one or more fuel structures 100.

The cladding material 114 may exhibit a shape (e.g., tubular, etc.) substantially similar to the shape of the fuel structures (e.g., fuel structure 100) contained therein. The shape of the cladding material may be formed by way of one or more processes, including but not limited to, a laser additive process, a vacuum induction melt, a hot isostatic press, hot extrusion, hydrostatic extrusion, tube pilgering, gun-drilling, tube drawing processes with inter-pass annealing, or combinations thereof.

The cladding material 114 and/or the pressurized fuel rod housing 112 may include a biasing means (e.g., springs, detent, coil, and combinations thereof) for biasing the array 116 of fuel structures and/or the cladding material 114 within the pressurized fuel rod housing 112. The cladding material 114 may further include a barrier coating (e.g., a physical vapor deposited (PVD) chromium, chromium nitride (CrN), or titanium nitride (TiN) coating).

The number/quantity of nuclear fuel structures 100 within the array 116 of fuel structures may vary depending on a number of factors, including but not limited to, a desired effect (e.g., decrease/absorption of fuel reactivity), a life cycle of the nuclear system, a life cycle of surrounding fuel rods, a life cycle of the fuel rod assembly 110, and combinations thereof. For example, the fuel rod assembly 110 may comprise all or a majority (e.g., greater than 50%) of the nuclear fuel structures 100 within the array 116 of fuel structures; or, the nuclear fuel structure 100 may comprise less than all or less than a majority of the fuel structures 100 within the array 116 of fuel structures. By way of a non-limiting example, a second nuclear fuel structure 101 may be present in the array 116, where the fuel structure 100 is different from the second nuclear fuel structure 101 at least with respect to the type and quantity of fissile material forming the respective structures. In this regard, the nuclear fuel structure 101 may include a single type of fissile material, such as UO₂ (e.g., a fissile material having less IBA or no IBA relative to the nuclear fuel structure 100). In other embodiments, there is no pairing in number of nuclear fuel structures 100, 101. Rather, one type of nuclear fuel structure (e.g., nuclear fuel structure 101) may exceed the other type of fuel structure (e.g., fuel structure 100) in number/quantity by a factor of two, three, four, five, six, and more. The nuclear fuel structure 101 may also have one or more different internal structures 108 and/or internal micro-scale characteristics than the nuclear fuel structure 100.

In other embodiments, the number/quantity, composition, and arrangement of the nuclear fuel structures 100 and 101 creates a gradient distribution of the IBA throughout the array 116 of fuel structures. For example, a first nuclear fuel structure 100 in the array 116 may include a 90/10 wt % ratio of UO₂ to UB₂, a second nuclear fuel structure 100 may include an 80/20 wt % ratio of UO₂ to UB₂, a third nuclear fuel structure 100 may include a 70/30 wt % ratio of UO₂ to UB₂, and so on. This pattern, or a similar pattern, may be continued until the last one or more fuel structures in the array 116 of fuel structures comprises the nuclear fuel structure 101, which does not have any IBA included therein. In this or a similar manner, a gradient of IBA relative to the height of the fuel rod assembly 110, or a portion thereof (e.g., along a height of the pressurized housing or cladding material), may be created.

Referring to FIG. 2B, the deconstructed assembly view depicts an arrangement of the components of the fuel rod assembly 110 relative to one another. For example, the nuclear fuel structure 100 is a component of the array 116 of fuel structures, and is contained within (e.g., fully or partially housed) the cladding material 114. In other words, when assembled, some embodiments of the fuel rod assembly 110 include the cladding material 114 radially or laterally adjacent to the nuclear fuel structure 100. The cladding material 114 is contained within the pressurized fuel rod housing 112. In other words, when assembled, some embodiments of the fuel rod assembly 110 include the cladding material 114 radially or laterally adjacent the pressurized fuel rod housing 112.

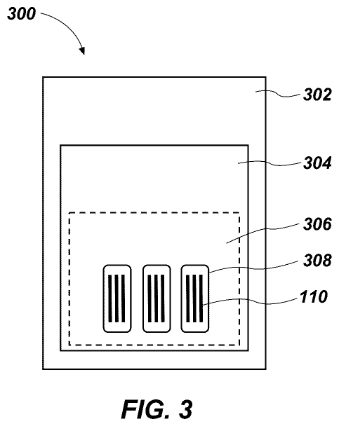

Referring to FIG. 3, a nuclear energy system 300 may include a nuclear reactor 302, a reactor core 304, a coolant medium 306, multiple pressure vessels 308, and an array of fuel rod assemblies 110. The nuclear reactor 302 may include one or more of lead-fast reactors, fast-neutron reactors, space reactors, micro reactors, and small modular reactors (SMRs), HWRs, LWRs, PWRs, BWRs, laser-driven neutron source reactors, and similar reactor energy systems.

The reactor core 304 comprises the multiple pressure vessels 308 in fluid communication with the coolant medium 306, such that a pressure vessel of the multiple pressure vessels 308 facilitates the in-flow and out-flow of the coolant medium 306. The reactor core assembly 304 may comprise one or more materials that exhibit high resistance to irradiation. For example, the reactor core assembly 304 may be made up of a chromium molybdenum (CrₓMo_{y}) steel (e.g., 12Cr-1MoVW HT9 steel, a nitrogen doped CrMo steel, a CrₓMo_{y}Ni_{z} steel, etc.), coated steels (e.g., to prevent carbon ingress), and similar high-resistance materials. The reactor core assembly 304 may include additional structures that are not depicted (e.g., baffles).

The multiple pressure vessels 308 may be arranged according to a desired energy output. The arrangement of the pressure vessels 308 may be a series or a parallel arrangement, and is accomplished using processes known in the art. In some embodiments, two or more pressure vessels may be arranged relative to one another to obtain the desired energy output or to offset excess reactivity depending on a life cycle of the nuclear reactor 302, a pressure vessel of the multiple pressure vessels 308, and/or a fuel rod assembly 110 within the pressure vessel.

The coolant medium 306 (e.g., light water, heavy water, molten sodium/salt, etc.) is circulated throughout the reactor core 304 using known systems (e.g., pumps, nozzles, etc.). The reactor core 304 may be segmented or divided into different groups or arrays of fuel rod assemblies 110, such that each group or array has their own, individual arrangement (e.g., hexagonal, octagonal, etc.). In some embodiments, an array 116 is configured to have the same arrangement as another array 116 of fuel rod assemblies 110.

A relative arrangement (e.g., location within the core relative to one another) of the segments, divisions, or groups of arrays of fuel rod assemblies 110 may be based on a number of factors, including but not limited to, an assigned core position, an enrichment level, an IBA/ATF composition within the array of fuel rod assemblies 110, and an individual fuel structure composition (e.g., fissile material content, ATF content, etc.) within an individual fuel rod assembly 110. The individual fuel rod assemblies 110 within an array of fuel rod assemblies 110 may be further arranged based on a number of factors, including but not limited to, ATF composition within the individual fuel rod assembly 110 and individual fuel structure composition (e.g., fissile material content within nuclear fuel structure 100). For example, a first pressure vessel of the multiple pressure vessels 308 having a high ATF composition may be positioned proximal a second pressure vessel of the multiple pressure vessels 308 having a relatively lower ATF composition as compared to the first pressure vessel. By way of another example, a pressure vessel having a longer lifetime than another pressure vessel may be positioned proximal to the other pressure vessel due to an amount of IBA/ATF remaining within its array of fuel rod assemblies 110.

In some embodiments, the arrangement of the multiple pressure vessels 308 is based on the micro-scale characteristics of individual fuel structures within an individual pressure vessel relative to another pressure vessel of the multiple pressure vessels 308. For example, a pressure vessel that has a total thermal conductivity (e.g., based on the micro-scale characteristics of individual fuel structures housed therein) greater than another pressure vessel may be placed proximal or adjacent to the other pressure vessel.

A first pressure vessel includes fuel rod assemblies 110 with alternating nuclear fuel structures 100 and nuclear fuel structures 101. The alternation of the placement of the fuel structures within the fuel rod assembly 110 results in fuel structures 100 with an IBA uniformly dispersed throughout the first pressure vessel. In some embodiments, this first pressure vessel may be placed near a second pressure vessel of the multiple pressure vessels 308 that contains a lesser number (i.e., non-uniformly dispersed number) of nuclear fuel structures 100 as compared to the first pressure vessel, or a different alternating sequence of fuel structures.

Similarly, a fuel rod assembly 110 within an array 116 of fuel rod assemblies 110 may be arranged relative to another fuel rod assembly based on a number of factors, including but not limited to, an assigned pressure vessel position, an enrichment level (e.g., 3% vs. 5% U-235 enrichment), an IBA/ATF composition within the fuel rod assembly 110, and an individual nuclear fuel structure composition (e.g., fissile material content, ATF content, etc.) within the fuel rod assembly 110.

In some embodiments, the arrangement of an array of fuel rod assemblies 110 is based on the internal structures 108 of individual fuel structures within an individual fuel rod assembly 110 relative to another fuel rod assembly 110 of the array of fuel rod assemblies 110. For example, a fuel rod assembly 110 that has an average grain size of about 3 microns (based on individual fuel structures housed therein) may be placed proximal or adjacent to another fuel rod assembly that has an average grain size of greater than about 30 microns (based on individual fuel structures housed therein).

The array of fuel rod assemblies 110 may be operably coupled to a pressure vessel of the multiple pressure vessels 308 using a variety of coupling means (e.g., upper and lower core plates, brazed plugs, endcaps, control rod drive mechanisms, welds, melt pool joining, friction stir welding (FSW), etc.).

The array of fuel rod assemblies 110 may further include a rod cluster control mechanism for adjusting one or more control parameters (e.g., coolant flow) relative to the array of fuel rod assemblies 110. The rod cluster control mechanism may be further configured to communicate one or more variables (e.g., fissile material content, fuel rod life cycle, IBA content, etc.) to a system controller (e.g., nuclear plant central computer) at a specific time (e.g., at startup) using a wired or wireless communication means (e.g., transmitter, radio frequency identification (RFID) tag, etc.).

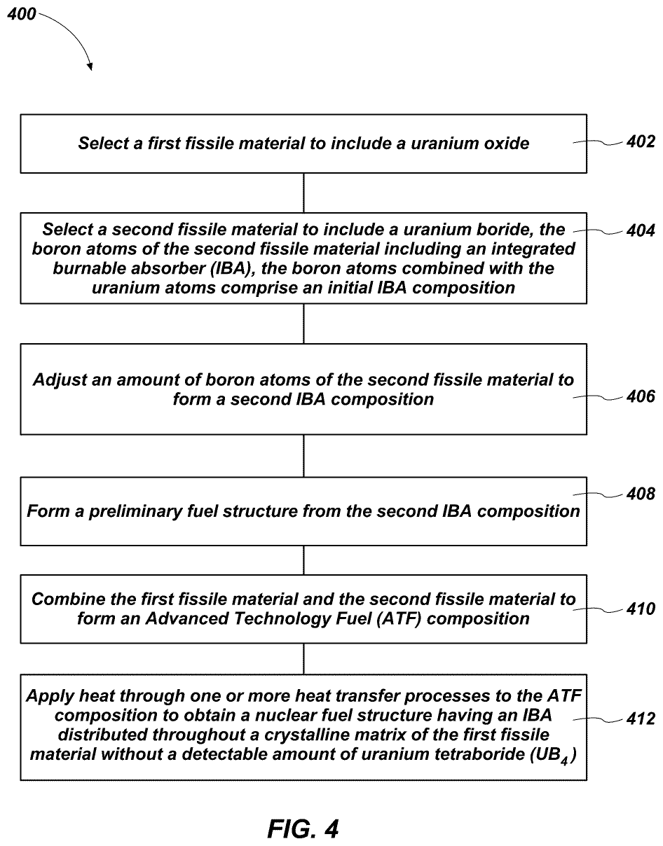

Referring to FIG. 4, a method 400 of forming a fuel structure 100 from a fissile composition comprising at least two different fissile materials includes the act 402 of selecting a first fissile material 104 to include a uranium oxide. The act 402 may include selecting a synthesizing process used to obtain a desired internal structure 108 or micro-scale characteristic using the selected first fissile material. For example, UO₂ may be used as the first fissile material 104 due to its availability, its crystalline structure after heat transfer, its uranium density, or a combination of these or other factors. The synthesizing process may be selected as the reduction of uranium trioxide to form UO₂.

The method 400 further includes the act 404 of selecting a second fissile material 106 to include a uranium boride compound, the boron atoms of the second fissile material 106 comprising an integrated burnable absorber (IBA), which when combined with the uranium atoms of the second fissile material 106 make up an IBA composition. The act 404 may include selecting a synthesizing process used to obtain a desired internal structure 108 or micro-scale characteristic using the selected second fissile material 106. For example, a borothermic reduction of UO₂ to form UB₂ may be used according to Equation (1), or a similar formula, as follows:

2UO₂₍ₛ₎+B₄C₍ₛ₎+3C₍ₛ₎→2UB₂₍ₛ₎+4CO_{(g)} Eq. (1)

By way of another example, UB₂ may be selected as the second fissile material 106, and a phase diagram may be used to aid in the selection of the synthesizing process to obtain the desired internal structure 108 or micro-scale characteristic. For example, in one portion of a phase diagram, UB₂ remains as a line compound, or the compound remains in a single phase until reaching relatively high temperatures (e.g., pure UB₂ shifts phases or melts at about 2385° C.). Thereafter (i.e., at temperatures greater than about 2385° C.), according to a U—B phase diagram, a small amount of impurities (e.g., UB₄) may facilitate degradation, or moving into a two-phase system, at lower temperatures (e.g., temperatures less than about 2385° C. and greater than about 2300° C.). In other words, the act 404 may include a selection based at least on the phase properties of UB₂ and related constituents (e.g., UB₄) within the binary uranium-boron (U—B) system.

The act 404 may further include selecting an appropriate combination (i.e., second fissile material 106 relative to the first fissile material 104) of fissile materials based on additional factors. For example, UB₂ may be selected based on its ability to enrich the existing micro-scale characteristics of the selected first fissile material 104 (e.g., UO₂). Because UB₂ has a significantly higher thermal conductivity and theoretical density than UO₂, it may be chosen as the second fissile material 106 based on these qualities. Other factors that may affect this selection include, but are not limited to: a uranium loading fraction; an ability to obtain a desired shape and size; interfacial thermal conductivity of intermolecular structures; a relatively high activation energy required for vacancy migration; an ability to facilitate smaller temperature gradients during reactor startup; an ability to facilitate a flatter temperature profile across the fuel structure; an ability to maintain structural integrity of the fuel structure wherein it is used and reduce irradiation damage; an ability to increase fuel residence time and reactor lifetime; enabling a lower centerline temperature for a given power output, which would generate a greater safety margin in the event of a meltdown; the ability to create lower thermal strain, less severe fuel structure and cladding interactions, a lower Cumulative Damage Factor (CDF), and a lower rate of release of fission products.

Upon selecting the first and second fissile materials 104, 106, including the appropriate IBA and synthesizing processes, physical parameters are used to obtain the desired internal structure 108 and the desired micro-scale characteristics without the use of costly heat transfer processes, such as SPS or FAST sintering. Accordingly, act 404 includes obtaining a desired particle size and/or particle size distribution, which affects the achievable internal structure 108 and the micro-scale characteristics of the nuclear fuel structure 100. For example, UB₂ may be milled together with a milling aid (e.g., polyethylene glycol (PEG)) to obtain particles less than about 40 microns in diameter.

The act 406 includes adjusting an amount of boron atoms of the second fissile material 106 to form an ATF composition of the nuclear fuel structure 100 without a detectable amount of uranium tetraboride (UB₄). The adjustment may occur prior to any heat transfer to the nuclear fuel structure 100 and prior to heat transfer to the preliminary fuel structure. The adjustment accounts for volatilization during subsequent heat transfer processes. For example, in act 404, the second fissile material 106 may be selected to include UB₂ as a component of the ATF composition of the nuclear fuel structure 100. Based on this selection, the act 406 includes combining the components of the second fissile material 106, including the IBA and uranium, according to predetermined baseline amounts, such as predetermined weight ratios, to form an initial IBA composition. The act 406 further includes adjusting the initial IBA composition to form a second IBA composition.

In some embodiments, baseline amounts of boron atoms and uranium atoms in the initial IBA composition may be combined at about 67 atomic % B (8.4 wt % B) and 33 atomic % U (91.6 wt % U) (e.g., about 1 gram of boron per about 10.93 grams of uranium). Understanding that certain materials (e.g., boron in UB₂) may be volatilized under higher temperatures, the second IBA composition includes additional components (e.g., boron atoms) of the second fissile material 106 to account for the first heat transfer process (e.g., to account for volatilization during arc-melting). In some embodiments, the second IBA composition includes about 67.2 at % B, or about 8.48 wt % B and about 32.8 at % U, or about 91.52 wt % U (e.g., about 1 gram of boron per about 10.79 grams of uranium).

In some embodiments, the total composition of the second fissile material 106 comprises from about seven (7) to about nine (9) wt % boron prior to conducting the first heat transfer process. In some embodiments, the total composition comprises from about eight (8) wt % to about 8.5 wt % boron just prior to the first heat transfer. In other words, the additional amount of boron prior to conducting the first heat transfer process comprises from about 0.08% to about 2% by wt % additional boron relative to the total uranium and boron in the second fissile material 106.

As discussed in detail below, some of the acts of method 400 may be repeated for subsequent production cycles. In the first production cycle, the act 406 of adjusting material compositions is not optional to obtain the desired internal structure 108 and the desired micro-scale characteristics. In subsequent production cycles (e.g., prior to a final heat transfer process), the act 406 of adjusting material compositions may be optional.

The method 400 further includes the act 408 of forming a preliminary fuel structure. For example, the preliminary fuel structure may be formed by placing the second fissile material 106 in a die or mold, and placing the die or mold under arc-melting conditions. In a subsequent production cycle, the nuclear fuel structure 100 may be formed from the preliminary fuel structure by placing a structurally-manipulated (e.g., deconstructed or milled) form of the preliminary fuel structure, together with the first fissile material 104, under sintering conditions.

The act 408 may further include selecting an appropriate macro-level characteristic for the preliminary fuel structure. For example, a disc shape may be selected based on a combined property of the first and second fissile materials selected in acts 402 and 404, and an intended outcome relative to the combined property (e.g., a disc-shape may be selected because of the ease of fragmentation and mixing of UO₂ together with UB₂ as a result of that external shape). The act 408 may result in an ingot, puck, or disc of the second fissile material 106.

The act 408 may further include testing the intermolecular, microstructural, chemical, and/or physical properties of the preliminary fuel structure. The testing may be optional. For example, in some embodiments, the first heat transfer process includes annealing, and tests for appropriate phases in the preliminary fuel structure may occur prior to the annealing to determine if the arc-melting facilitated or resulted desired micro-scale characteristics within the preliminary fuel structure (i.e., to determine whether or not annealing is necessary). These tests may help avoid a costly annealing heat transfer process if the product of the previous heat transfer process (arc-melting) already met desired specifications. A thermal conductivity microscope (TCM) may be used to measure thermal diffusivity and thermal conductivity using modulated thermoreflectance. A laser flash analyzer (LFA) may, for example, be used to measure thermal diffusivity, such as a Netzsch LFA 427, adhering to ASTM E1461-13, Standard Test Method for Thermal Diffusivity by the Flash Method. Microstructural characteristics may be examined with backscattered electrons (BSE) using a secondary electron microscope (SEM) equipped with energy dispersive spectroscopy (EDS) for elemental identification and mapping. Microstructural characterization, including phase quantification and grain size analysis, may be performed using the image analysis software.

The act 410 may include combining the first fissile material 104 and the second fissile material 106 and forming a predetermined external structure. The act 410 may include deconstructing, or milling, the ingot, puck, or disc of the second fissile material 106 to combine it with the first fissile material 104. The act 410 may include selecting an appropriate macro-level characteristic for the nuclear fuel structure 100. For example, a right-cylinder, annular, or a pellet shape may be selected based on the desired external structure 107 of the first and second fissile materials 104, 106 selected in acts 402 and 404. In other embodiments, the formation of the nuclear fuel structure 100, and its external shape, may be further based on one or more desired system-level effects (e.g., reduced temperature within a pressure vessel or a reduced pressure relative to the gas plenum).

The act 410 may include meeting one or more physical property constraints as a result of the combination. For example, the resulting combination of UO₂ and/or UB₂ may be passed through a -400 mesh sieve, ensuring particles are less than about 40 microns in diameter. Careful control of the parameters under act 410 may facilitate the obtaining of the desired internal structure 108 and the desired micro-scale characteristics.

The act 412 may include applying one or more heat transfer processes to the external structure 107 to obtain the nuclear fuel structure 100 having the internal structure 108 comprising the IBA distributed throughout a matrix of the first fissile material 104. The transfer of heat to the nuclear fuel structure 100 occurs under inert conditions, at the predetermined parameters for the respective heat transfer process. For example, a first heat transfer process may be applied to the preliminary fuel structure, comprising the second fissile material 106, and may include arc-melting. In other embodiments, the first heat transfer process may include both arc-melting and annealing. The predetermined parameters of the first heat transfer process may include using a controlled environment, such as an argon gas environment to reduce the effects of oxidation on the nuclear fuel structure 100.

The act 412 may include repeating any of the acts 404 to 412 after the first heat transfer process of act 412. For example, an X-ray diffraction (XRD) test and/or an SEM test may indicate that certain properties of the preliminary fuel structure need to be adjusted prior to obtaining the desired internal structure 108 and/or the desired micro-scale characteristics. Accordingly, additional milling, under act 410, or additional heat transfer, under act 412 (e.g., annealing), may occur before proceeding to the final production cycle (e.g., before proceeding to the final heat transfer process).

The act 412 may include applying a final heat transfer process to the external structure 107 to obtain the nuclear fuel structure 100 having the internal structure 108 comprising the IBA distributed throughout a matrix of the first fissile material 104. The final transfer of heat to the nuclear fuel structure 100 occurs under inert conditions, at the predetermined parameters for the final heat transfer process. For example, the final heat transfer process may be applied to the external structure of a compacted, combined form of the first fissile material 104 and the second fissile material 106, and may include sintering. The predetermined parameters of the final heat transfer process may include using a controlled environment, such as an ultra-high purity (e.g., less than or equal to about 1 ppm O₂) argon gas environment to reduce the effects of oxidation on the nuclear fuel structure 100.

The act 412 may include additional tests performed on a nuclear fuel structure 100 to determine if the desired internal structure 108 and/or the desired micro-scale characteristics will be, or have been, obtained and method 400 should end. For example, after subsequent production cycles (e.g., a final heat transfer process) if a density of greater than about 95% of a calculated theoretical density is obtained for the nuclear fuel structure 100, then the method 400 may end.

Careful control of the parameters under act 412 may further facilitate obtaining the desired internal structure 108 and the desired micro-scale characteristics of the nuclear fuel structure 100. For example, the careful control may be obtained by retrofitting or upgrading a sintering furnace from analog mass flow controllers to digital controllers, installing oxygen monitors for gas flow in and out of the furnace, removing or replacing thread-sealing points (e.g., desiccant filter).

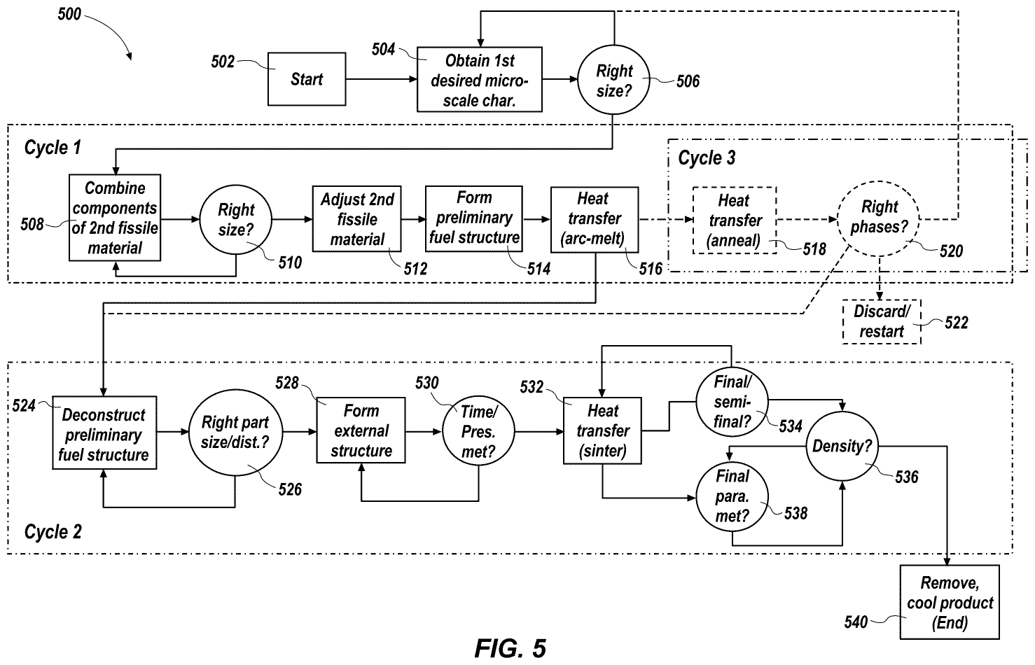

Referring to FIG. 5, a more detailed method 500 for forming a fuel structure (e.g., nuclear fuel structure 100) includes a starting act, 502, such as selecting appropriate fissile materials, IBA types, and/or ATF compositions. The act 502 may include additional acts known in the art, such as cleaning uranium rods, resizing or portioning the clean rods, having the rods undergo hydride/dihydride processes to break apart the rods into more granular units, and other acts and processes used in preparing raw fuel rods for manufacturing fissile materials.

Act 504 includes obtaining a first desired micro-scale characteristic. For example, mechanical grinding, milling, ball milling, or other powderization techniques may be used to obtain a desired particle size and/or particle distribution.

Act 506 includes making a first micro-scale characteristic determination. For example, a size and/or particle distribution determination may be conducted by passing particles through a mesh sieve.

When the appropriate size and/or particle distribution is obtained, the act 508 includes combining the components of the second fissile material 106 (e.g., adding boron to uranium to form the initial IBA composition) according to predetermined baseline amounts. Act 508 may further include additional milling of the components of the second fissile material 106 based on the determination in subsequent act 510.

The act 510 includes making a second micro-scale characteristic determination. For example, another size and/or particle distribution determination may be made by requiring the combined components of the second fissile material 106 to pass through a 400 mesh sieve.

When the appropriate size and/or particle distribution of the components of the second fissile material 106 are not obtained, the method 500 returns to act 508 for additional milling. When the appropriate size and/or particle distribution of the components of the second fissile material 106 is obtained, the act 512 includes adjusting one or more materials of the second fissile material 106 to account for volatilization in anticipation of a subsequent heat transfer process. For example, an amount of the IBA in the second fissile material 106 may be increased to form a second IBA composition that is used in forming a preliminary fuel structure, which undergoes arc-melting.

The act 514 includes forming the preliminary fuel structure at predetermined parameters. For example, the act 514 may further include selecting an appropriate macro-level/external characteristic for the preliminary fuel structures and compacting/shaping based on the selection. By way of another example, the act 514 may include selecting appropriate micro-characteristics for the preliminary fuel structure, and shaping/compacting based on the selection. For example, the shear modulus (e.g., calculated using the Voigt-Reuss-Hill averaging scheme at room temperature) of the second fissile material 106 may be selected to be about 216 GPa to about 275 GPa, and the shaping/compacting of the preliminary fuel structure may occur relative to the shear modulus. Accordingly, after the desired macro-level and micro-level characteristics have been selected and/or obtained, the components of the second fissile material 106 may be compacted or pressed into a shape using a mold or die.

The act 516 includes applying first heat transfer conditions, including providing an inert atmosphere for the first heat transfer processes. For example, the first heat transfer process may be an arc-melt process using a STA Reed Tri-Arc, Centorr Vacuum Industries™ furnace, and the inert atmosphere may comprise a relatively pure gettered argon gas stream (e.g., less than or equal to about 15-20 ppm O₂, where metallic zirconium may act as a getter for oxygen). In other embodiments, the inert atmosphere comprises another inert gas, such as helium.

The act 518 may be optional depending on the desired internal structure 108 and/or the desired micro-scale characteristics seeking to be obtained. For example, the act 518 may include applying annealing conditions to the preliminary fuel structure within an inert atmosphere, thereby comprising another heat transfer process relative to the first heat transfer process. In other words, in some embodiments, the first heat transfer process, at least for the purposes of this disclosure, may encompass both the arc-melting and annealing processes, despite these being separate and distinct heat transfer processes. In other embodiments, the first heat transfer process does not include annealing.

The act 520 may be optional, and includes determining whether appropriate phases, grain sizes, porosity, and other intermediary micro-scale characteristics have been obtained. For example, the lattice parameters of the internal structure of a preliminary fuel structure may be determined to be about a=3.082 angstroms, b=3.082 angstroms, and c=4.019 angstroms for UB₂, while for UO₂ the lattice parameters may be about a=b=c=3.833 angstroms; and, preliminary phase analysis may be performed to indicate amounts of the UB₂, UB₄, and UB₁₂ phases present in the preliminary fuel structure. Act 520 may prevent having the preliminary fuel structure undergo a final heat transfer process (e.g., sintering), without having met certain threshold criteria (e.g., phase purity as indicated by the phase analysis or lattice structure as indicated by lattice parameters). When possible, if threshold criteria are not met, the preliminary fuel structure may undergo one or more previous steps (e.g., act 504). In other embodiments, at act 522, the preliminary fuel structure may be discarded if threshold parameters are not met, and the process restarted and adjusted in order to obtain the desired intermediary internal structure and/or micro-scale characteristics.

The act 524 may include deconstructing the preliminary fuel structure formed from arc melting. For example, ingots of the second fissile material 106 resulting from the arc-melting process may be comminuted, and the deconstructed form of the second fissile material 106 milled together with a powder form of the first fissile material 104. One or more additives (e.g., 0.2 wt % polyethylene glycol (PEG)) may help in milling the ingots of the second fissile material 106. In some embodiments, the UO₂ powder may be blended with UB₂ ingots (i.e., deconstructed portions thereof) via a high energy ball milling process, such as at greater than 250 rpm for one hour, using a Retsch™ PM200 planetary ball mill, in a ZrO₂ milling jar with 5 mm diameter ZrO₂ media. The ratio of the powder to milling media may range from about a 5:1 to about a 20:1 ratio.

Act 526 may include making a third micro-scale characteristic determination. For example, another size and/or particle distribution determination may be made by passing the UO₂/UB₂ particles through a 400 mesh sieve. In some embodiments, the composite powder of the first fissile material 104 and the second fissile material 106 may be sufficiently milled to exhibit a bimodal average particle size of less than 10 microns.

The act 528 includes forming an external structure of the nuclear fuel structure 100. For example, “green pellets” may be formed from the UO₂/UB₂ particles by compacting or pressing the UO₂/UB₂ particles into a shape using a mold or die. The compaction may occur at pressures ranging from about 100 MPa to about 150 MPa, for about 30 seconds to about a minute. In some embodiments, the compaction occurs using about an eight (8) mm to about a 12 mm tungsten carbide (WC) die. In other embodiments, the size of the die may be increased or decreased depending on the nuclear energy system 300 for which the fuel structure 100 is intended.

The act 530 may include determining if one or more threshold parameters are met prior to removing the fuel structure from the mold or die. For example, a time or pressure requirement may be determined to have been met prior to removal.

The act 532 includes applying the final heat transfer conditions, which may include providing an inert atmosphere for the final heat transfer (e.g., sintering) process. In some embodiments, the sintering occurs in sintering furnaces that are available throughout the industry (i.e., that do not require substantial retrofitting, such as required by SPS or FAST methodologies). For example, appropriate sintering conditions may be obtained using a refractory metal sintering furnace, such as a Thermal Technology™ Model 1100, under an ultra-high purity environment (e.g., less than or equal to about 1 ppm O₂). The ultra-high purity environment may be created using an argon cover gas. The sintering temperature ranges from about 1500° C. (˜1773 K) to about 1900° C. (˜2173 K) for about four (4) or about eight (8) hours. In some embodiments, the sintering temperature ranges from about 1700° C. to about 1800° C. The pressure may be relatively low (e.g., pressure-less sintering). Temperature ramp/cool conditions may be about a 10-30° C./min ramp to the dwell temperature, and about a 10-15° C./min cooling down to room temperature. In some embodiments, the temperature ramp may be about a 15-25° C./min ramp. The sintering conditions may further include about a 1-2 hour dwell time at about 530° C. (800 K) to about 630° C. (900 K) for a PEG burnout.

The act 534 may include a final or semi-final micro-scale parameter/time determination regarding the nuclear fuel structure 100. For example, a sintering time threshold of about four hours may be determined to have been met.

The act 536 may include a density or other micro-scale parameter determination. For example, a density or porosity corresponding to a four-hour sintered pellet may have been met before proceeding. The density of a nuclear fuel structure 100 may be determined via the Archimedes measurement method in deionized water.

Returning to act 532 and 534, a semi-final or final parameter determination regarding the nuclear fuel structure 100 may be determined not to have been met, so heat transfer application is continued/reapplied.

The act 538 may include a final parameter/time determination regarding the nuclear fuel structure 100. For example, a sintering time threshold of about eight hours may be determined to have been met.

Returning to act 536, a final density, internal structure, and/or micro-scale parameter determination may be made. For example, a grain size, a porosity, or a final density corresponding to an eight-hour sintered pellet may be determined to have been met.

Upon meeting the time, internal structure, and/or micro-scale parameter requirements of acts 534 through 538, act 540 may include cooling the nuclear fuel structure 100. For example, the sintered pellets may be removed from the sintering furnace and allowed to cool under ambient or forced air conditions. The act 540 may further include one or more additional tests to ensure that desired internal structure 108 and/or micro-scale characteristics are obtained.

Referring again to FIGS. 4 and 5 and the act 512 of adjusting or adding the additional amount of IBA (e.g., boron) to the UB₂ compound may facilitate significant advantages relative at least to SPS fuel structures. For example, although the addition of boron may temporarily move the compound into the UB₄/UB₂ phase region of a corresponding U—B phase diagram, X-ray diffraction (XRD) and phase identification performed (see Example 1, below) according to act 412 and/or act 536, failed to identify UB₄ in the final nuclear fuel structure 100. Only UO₂ and UB₂ were identified in the nuclear fuel structure 100. No UB₄ crystalline phase was identified. This indicates that the IBA constituents of the nuclear fuel structure 100 may be tailored by adjusting the boron atoms present in the second fissile material 106 prior to the first heat transfer process. Because no UB₄ is detected, only the beneficial properties of the UB₂ component of the binary U—B system are present in the nuclear fuel structure 100 after the final heat transfer process. In other words, without being bound by theory, the increase in thermal diffusivity of the nuclear fuel structure 100 over the conventional SPS fuel structures may be because boron atoms were adjusted prior to the first heat transfer such that no UB₄ was detected in the final nuclear fuel structure 100 (i.e., a fuel structure is produced without including any detectable amount of UB₄). Therefore, the phase purity of the nuclear fuel structure 100 helped facilitate improvements to the nuclear fuel structure 100 relative to conventional fuel structures. Another contributing factor to improved nuclear fuel structure properties (e.g., diffusivity values) relative to conventional SPS fuel structures, without being bound by theory, may be the increased density relative to the SPS fuel structures (e.g., about a 15 wt % UB₂ SPS fuel structure was found to be about 92.4% theoretical density (TD), as compared to the approximately 96% TD for the nuclear fuel structure 100).

In accordance with one embodiment described herein, a fuel rod for a nuclear energy system comprises a pressurized housing, an array of fuel structures within the pressurized housing, and cladding material between the array of fuel structures and the pressurized housing. A fuel structure of the array of fuel structures comprises an ATF composite body including a first fissile material and a second fissile material. The second fissile material includes an integrated burnable absorber (IBA). The ATF composite body further includes one or more additives, and has one or more micro-scale characteristics, such as a fissile material density within a range of 10 to 12 g/cm³.

In further embodiments described herein, a method of forming a fuel structure for a nuclear reactor comprises forming a composite body comprising at least two different fissile materials. A preliminary fuel structure is formed from an ATF composition. The preliminary fuel structure undergoes at least a first heat transfer processes to form a secondary structure. The secondary structure undergoes a second heat transfer process to interconnect the ATF within a matrix of the first fissile material and obtain one or more desired micro-scale characteristics (e.g., density, porosity, or crystalline size/structure).

In further embodiments, another method of forming a fuel structure from a fissile composition is described. The method includes forming the fuel structure from at least two different fissile materials, and includes: selecting a first fissile material having a first fissile material density within a range of nine grams/cm³ to 11 grams/cm³; selecting a second fissile material having a second fissile material density within a range of 10 grams/cm³ to 13 grams/cm³; forming a preliminary fuel structure, comprising a composite body having a cylindrical shape from an IBA composition; combining the first fissile material and the second fissile material to form a homogeneous ATF composition; and applying one or more heat transfer processes to one or more preliminary fuel structures, obtaining a micro-scale characteristic including a third fissile material density within a range of 10 to 12 g/cm³.

In yet further embodiments, an energy system comprises a nuclear reactor comprising a reactor core having a plurality of pressure vessels in fluid communication with a coolant medium that flows in and out of a plurality of pressure vessels including an array of fuel rod assemblies. A first fuel rod assembly of the array of fuel rod assemblies includes a pressurized fuel rod housing, a cladding material laterally adjacent the pressurized fuel rod housing, and a first fuel structure comprising a first fissile material and a second fissile material including an ATF integrated with one or more additives. The first fuel structure has one or more micro-scale characteristics, including a first heat capacity, Cₚ, value within a range of 0.20 to 0.50 (J/g-K).

### EXAMPLES

### Example 1: Phase Identification and Microstructural Properties of Fuel Structures

Different fuel structures were prepared in accordance with embodiments of the disclosure. The different fuel structures were prepared by blending a powder form of UO₂ (available for purchase from AREVA™) with a uranium diboride (UB₂) powder, pressing the powders into pellets of right cylindrical geometry, and sintering the pellets for different amounts of time (e.g., about 4 hours and about 8 hours, respectively).

The UB₂ powder was synthesized via a powder metallurgy and arc-melting technique, combining elemental uranium (e.g., available from Alfa Aesar® with 99.5% purity) and powdered boron. Stoichiometric amounts of boron and uranium were used in preparing baseline amounts of the UB₂ powder for arc-melting. At baseline amounts, UB₂ has a boron percent of composition of about 8.4 wt % (e.g., about 67 to about 68.5 at % B) and a uranium percent of composition of about 91.6 wt % (e.g., about 31.5 to about 33 at % U). To account for the possibility of boron volatilization during arc-melting, the boron was adjusted beyond the baseline amounts just prior to arc-melting. Therefore, the compositions actually undergoing arc-melting included non-stoichiometric amounts of boron and uranium, with the final content prior to arc-melting having a boron percent of composition of 8.48 wt % (i.e., atomic percentage of about 67.2 to about 68.7 at % B), a uranium percent of composition of 91.52 wt % (i.e., atomic percentage of about 31.3 to about 32.8 at % U). In other words, in some embodiments, the molecular formula for the uranium diboride compound is approximately UB_{2.05}, and in other embodiments the molecular formula for the uranium diboride compound is approximately UB_{2.2}. Prior to arc-melting, the temporary percent of composition is estimated to be about 98.9 wt % UB₂ and about 1.1 wt % UB₄. Arc-melting was performed under an inert atmosphere, having less than or equal to 20 ppm oxygen (O₂). These arc-melted materials were comminuted. Polyethylene glycol (PEG) was used to aid in the milling of the arc-melted UB₂ puck/ingot. Once the UB₂ was in powder form (e.g., particles <37 μm) it was combined with the UO₂ powder and prepared for sintering.

The UO₂ powder exhibited a bi-modal average particle size of about 7 microns and about 20 microns prior to sintering. The UB₂ powder exhibited a bi-modal average particle size of about 2 microns prior to sintering. The particle sizes were determined using X-ray sedimentation analysis using a Micrometrics™ Sedigraph III 5120.

To prepare for sintering, the powders were blended via a high energy ball milling process. The milling process utilized a Retsch PM200 planetary ball mill operating at 315 rpm for one (1) hour. The planetary ball mill utilizes a ZrO₂ milling jar with five (5) mm diameter ZrO₂ media. The media to powder ratio is about an 8:1 ratio. The milled powder was passed through a 400-mesh (37 micron) sieve prior to pressing the powder into pellets of right cylindrical geometry. The pellets included both UO₂ and UB₂, and are referred to herein as composite pellets, and were formed using an automated Carver® hydraulic press, at about 120 MPa, using about 9.7 mm WC die (i.e., tooling is tungsten carbide (WC)). The composite pellets were sintered in a refractory metal sintering furnace (Thermal Technology™ Model 1100) under flowing ultra-high purity argon cover gas at about 2073 K (˜1800° C.) (e.g., including fuel structures sintered for about 4-hours and some for about 8-hours). The process included about 20 K/min ramp to dwell temperature, and about 15 K/min ramp/cool down to room temperature to examine the effect of dwell time on sintered density and microstructure. The dwell temperature of about 873 K (˜600° C.) lasts for about two hours, and is conducted to effect a PEG burnout. During sintering, the fuel structures were placed directly on a tungsten sintering plate within the hot zone of the furnace. The ultra-high purity argon cover gas included less than or equal to about 1 ppm O₂.

A phase identification using X-ray diffraction (XRD) was performed on the samples, including samples of the 4-hr and 8-hr composite fuel structures. A mixed UO₂/UB₂ powder sample (i.e., prior to sintering) was analyzed, comprising a 90 wt % UO₂, 10 wt % UB₂ blended powder. The composite fuel structure samples were prepared by grinding a final fuel structure with a mortar and pestle. Additional pellet samples were taken from 4-hr and about 8-hr pellets after thermal conductivity analysis had been performed. Because analysis of these samples used a laser flash analyzer, these samples are referred to as LFA 4-hr and LFA 8-hr samples. A Malvern Panalytical Aeris X-ray Diffractometer (Cu K_{α}, 40 kV, 15 mA, step-size 0.011 2θ) was used according to known methods for the phase identification. Final material composition via phase quantification of the sintered samples was carried out using Rietveld® refinement analysis within the Panalytical® HighScore+software. Rietveld® refinement was performed using a polynomial fit to the background and using a semiautomatic fitting profile. Profile fitting used the Pseudo-Voigt profile, and refinement was completed to generate a minimized weighted residual (R_{wp}) profile having a value of less than about 10.

Because the uranium-boron system potentially includes three stable, high-temperature melt point, intermetallic compounds (i.e., UB₂, UB₄, and UB₁₂), the phase identification analysis can identify which of the three compounds are present in the final fuel structures. The additional amount of IBA (e.g., boron atoms) added to the baseline boron amounts of the blended powder prior to arc-melting, was carefully controlled such that no UB₄ or UB₁₂ were detected in the final fuel structures.

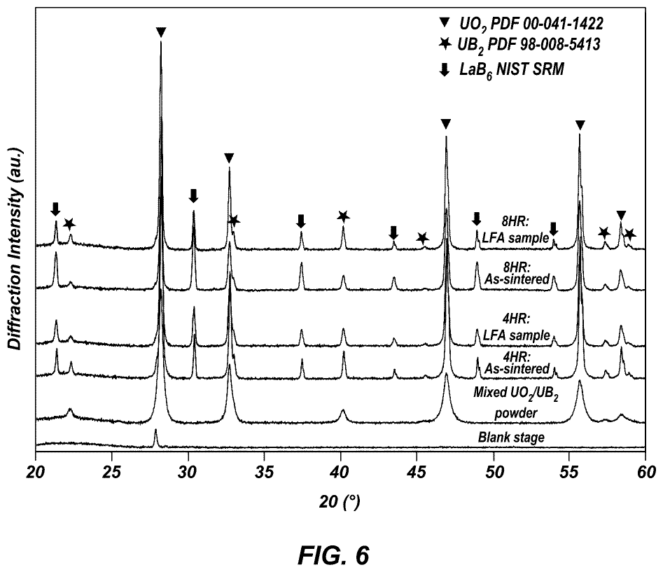

Referring to FIG. 6, the diffraction patterns for the 90% UO2/10% UB2 powder are depicted relative to the samples of 4-hr composite pellets, 8-hr composite pellets, 4-hr LFA composite pellets, 8-hr LFA composite pellets, and pure UO₂ and UB₂ powders (i.e., baseline powders comprising UO₂ PDF #00-041-1422, and UB₂, PDF #98-008-5413). The as-sintered and LFA samples included a LaB₆ National Institute of Standards and Technology standard reference material (NIST SRM) for line position verification. Comparing the patterns for samples shows that the UO₂ and UB₂ peaks in the mixed powder are broader than in the sintered samples for both the UO₂ and UB₂ phases, which is indicative of grain growth during sintering. Comparison of the full width half maximums (FWHM) for the first two peaks for both phases from the mixed powder and the 8-hour sintered sample (i.e., about 28.2 and about 32.7 2θ for UO₂, and about 22.3 and about 32.9 2θ for UB₂) show the FWHM decreased in the sintered sample. For the UO₂ phase the FWHM decreased from about 0.312 and about 0.324 to about 0.193 and about 0.190; and, in the UB₂ phase the decrease was from about 0.295 and about 0.326 to about 0.182 and about 0.174, indicating an increase in crystal size. The increase in crystalline size was calculated using the Scherrer equation, relating the size of sub-micron crystals in solids to broadening peaks seen in the diffraction patter. The pattern for the blank stage used in analysis is also listed in FIG. 6, and reflects a peak at 28.4° 2θ attributed to the silicon disk holder of the stage.

The UO₂ crystalline size of the UO₂/UB₂ mixed powder was about 22 nm in diameter; whereas, the crystalline size of the about 8-hr samples was about 45 nm in diameter. The UB₂ crystalline sizes in the mixed powder and the about 8-hr sintered sample were calculated to be about 23 nm and about 48 nm, respectively. Only UO₂, matching the powder diffraction file (PDF) #00-041-1422, and UB₂, PDF #98-008-5413 were identified in the samples. No UB₄ phase was identified.

Without being bound by theory, the phase identifications depicted in FIG. 6 indicate that despite the addition of boron, prior to arc-melting, and moving the compound into a UB₄/UB₂ region of a phase diagram, the additional boron may have volatilized during arc-melting, or any remaining UB₄ is below the resolution of the diffractometer. Because UB₂ has a higher theoretical uranium density than UB₄, the phase identifications depicted in FIG. 6 also indicate that the amount of boron added to the initial starting powder should be accurately determined. In other words, a balance may be struck, such that sufficient boron is added to compensate for volatilized amounts during arc-melting, but not too much in order to maintain the benefits of a composition with a desired amount of UB₂ relative to UB₄ (i.e., detectable amount of IBA consists of UB₂, and does not have a detectable UB₄ phase using a diffractometer).

### Example 2: Microstructural Properties of Fuel Structures

Fuel structure samples included the LFA about 4-hr, LFA about 8-hr, composite about 4-hr, and composite about 8-hr samples discussed in Example 1 (i.e., except without grinding with a mortar and pestle). The samples were prepared for microanalysis by mounting a fuel structure in epoxy followed by grinding with 1200 grit silicon carbide (SiC) paper. The pellets were ground approximately halfway through to create a cross-sectional surface that was perpendicular to the two parallel faces of the right cylinder. The cross-sectional surface was polished with MetaDi® diamond suspension fluid down to one (1) micron. The microstructure of the samples was examined with backscattered electrons (BSE) using a JEOL IT500HR secondary electron microscope (SEM) equipped with energy dispersive spectroscopy (EDS) for elemental identification and mapping. Images for microstructural image analysis were taken from multiple representative areas across a cross-sectional area on one planar surface. Microstructural characterization and analysis was performed using MIPAR™ analysis software.

The mean and median grain sizes of the UB₂ phase were about 1.9 microns and about 1.1 microns for the about 4-hr samples. The mean and median grain sizes of the UB₂ phase were about 2.7 microns and about 1.6 microns for the about 8-hr samples. The UB₂ phase fractions for the about 4-hr and about 8-hr samples were estimated at about 9.5%±2.0% and about 9.9%±1.6% UB₂, respectively.

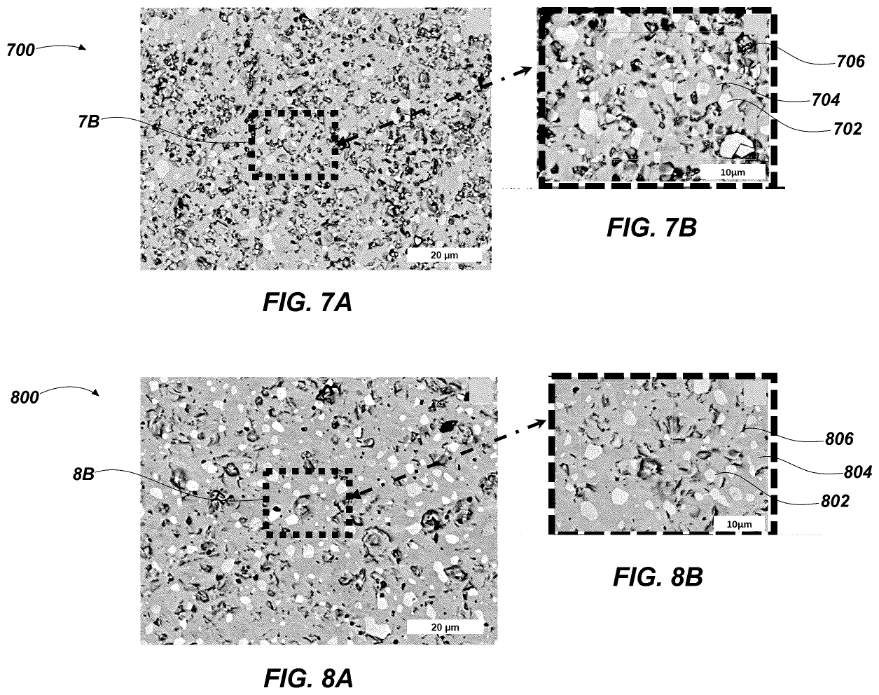

Referring to FIGS. 7A and 7B, the microstructure 700 of 4-hr sintered fuel structures indicate a uniform distribution of UB₂ 702 (light grey) throughout the UO₂ matrix 704 (dark grey). The microstructure 700 has a first porosity 706 (black).

Referring to FIGS. 8A and 8B, the microstructure 800 of 8-hr sintered fuel structures indicate a uniform distribution of UB₂ 802 (light grey) throughout the UO₂ matrix 804 (dark grey). The microstructure 800 has a second porosity 806 (black). The second porosity 806 of the 8-hr sample is less than the first porosity 706 of the 4-hr sample. This indicates a lesser degree of bonding between the phases of the 4-hr sample than in the 8-hour sample. The mean grain sizes of the UB₂ phase were 1.9 μm for the 4-hour samples and 2.7 μm for the 8-hour samples. The median grain sizes of the UB₂ phase were 1.1 μm for the 4-hour samples and 1.6 μm for the 8-hour samples.

### Example 3: Thermochemical and Thermodynamic Properties of Fuel Structures

Samples for thermochemical and thermodynamic analysis included about 4-hr and about 8-hr composite samples, prepared as discussed in Example 1, pure UB₂ and UO₂ powders (available from AREVA®), 5 wt % UB₂ prepared according to SPS methodologies, 15 wt % UB₂ prepared according to SPS methodologies, and a theoretical 90% UO2/10% wt % composite from literature (i.e., baseline Rule of Mixtures (ROM) calculations). Bulk thermal diffusivity measurements (mm²/sec) were performed using a Netzsch laser flash analyzer (LFA 427) adhering to ASTM E1461-13, Standard Test Method for Thermal Diffusivity by the Flash Method, to measure thermal diffusivity as a function of temperature. A cover gas of ultra-high purity argon was flowed at about 150 mL/min after passing through an Oxy-gon OG-120M O₂ gettering furnace, resulting in <1 ppm O₂ concentrations. A Pyroceram® 9606 standard was used to confirm the measurement accuracy within 2%. Five laser pulse shots (e.g., a laser pulse shot of about 0.6 ms in duration, and occurring in about three- (3) minute increments) were then taken and averaged at each temperature (e.g., about 323 K to about 1273 K) in about 100 K increments starting at about 373 K. The Cape-Lehman model integrated into the Netzsch® Proteus 4.8.5 software was used to calculate the thermal diffusivity measured from each shot.

Specific heat capacity (Cₚ) values (J/g·K) were measured using a Netzsch® DSC 404C Differential Scanning calorimeter (DSC) following the ASTM E1269-95 Standard Test Method for Determining Specific Heat Capacity by Differential Scanning calorimetry using a sapphire disc as a standard reference material. Measurement accuracy from this standard was ≤about 2.22%. Samples were placed into an yttria-lined platinum-rhodium crucible during testing. An ultra-high purity argon cover gas was flowed at about 50 mL/min after passing through an Oxy-gon OG-120M O₂ gettering furnace, resulting in about a less than one (1) ppm O₂ concentration in the argon gas atmosphere. DSC data was collected on two consecutive heating and cooling cycles from about 323 K to about 1273 K in about 25 K increments and the data analyzed with the Netzsch® Proteus 4.8.5 thermal analysis software.

The measured thermal diffusivity values and specific heat values from the ROM calculations for a theoretical 90% UO₂/10% UB₂ (i.e., wt %) composite were found using methods known in the art. In addition, the thermal expansion data was calculated based on the rule of mixtures using methods known in the art. Thermal conductivity results were calculated for the about 4-hr and about 8-hr, 90% UO₂/10% UB₂ (i.e., wt %) composites using Equation (2), below:

k=Cₚ*ρ*α Eq. (2)

where k, is thermal conductivity (W/m·K), Cₚ, is heat capacity (J/g·K), ρ, is density (g/cm³), and, α, is thermal diffusivity (mm²/sec) (although units of length are different, they cancel each other out in actual calculations).

The standard deviation of the thermal diffusivity measurements is used as the main source of reported error.

The tests for thermochemical and thermodynamic properties of the fuel structures occurred from about 0° C. (273 K) to ambient temperatures (about 25° C.), and further to about 1273 K (i.e., about 1000° C.).

The thermal conductivities of the 8-hr samples of composite fuel structures were calculated to be from about 11 W/m-K about 300 K to about 5 W/m-K at 1273 K. For the 4-hr samples, the thermal conductivities were calculated to be from about 12 W/m-K at about 300 K to about 4.5 W/m-K at about 1273 K. Pure UB₂ thermal conductivity values prepared according to SPS methodologies—as reported in literature (i.e., for 5 wt % UB₂) —were from about 9.5 W/m-K at about 300 K to about 5.5 W/m-K at about 873 K—and as reported in literature (i.e., for 15 wt %, UB₂) were from about 10.8 W/m-K at about 300 K to about 6 W/m-K at about 873 K. Pure UO₂ thermal conductivity values, as reported in literature, were from about 7.5 W/m-K at about 300 K to about 2.5 W/m-K at about 1273 K. ROM thermal conductivity values were from about 10 W/m-K at about 300 K to about 5.2 W/m-K at about 1273 K. The results indicated that the thermal conductivities of the 4-hr and 8-hr samples were higher than the pure UB₂ prepared using SPS methodologies. Both the about 4-hr and the about 8-hr samples of composite pellets exhibited an increase in thermal conductivity as compared to the baseline UO₂ values (e.g., about a 62-93% increase from 50° C. to 1000° C.). They also displayed an increase in thermal conductivity as compared to the 5 wt % and 15 wt % UB₂ SPS samples. The results further indicated that pure UB₂ had a greater thermal conductivity than UO₂ and exhibited an increase in thermal diffusivity above 1073 K. Without being bound by theory, this was likely due to its metallic nature.

The values for thermal conductivity (W/m-K) further indicated that both the 4-hr and 8-hr fuel structures exhibited increased thermal conductivity as compared to the pure UO₂ (e.g., about a 36-55% increase over about 50° C. (323 K) to about 1000° C. (1273 K)). Relative to the theoretical ROM (i.e., baseline) values, the 4-hr and 8-hr sintered samples exhibited about a 1-13% increase until reaching a temperature of about 700° C. (973 K). When the thermal conductivity values were corrected using a porosity correction equation often used in ceramic fuel corrections, the thermal conductivity values exhibited about an 8-10% increase across the temperature range examined.

The thermal diffusivities of the 4-hr and 8-hr sintered samples decreased with increasing temperature. Without being bound by theory, this was likely due to the influence of phonon-phonon scattering. The thermal diffusivity values for the composite samples (i.e., 4-hr and 8-hr) samples were about 4.0 mm²/sec at about 300 K and about 1.2 mm²/sec at about 1273 K. The thermal diffusivity values for the 15 wt % UB₂ SPS sample were substantially equal to those of the 4-hr and 8-hr samples until about 1073 K. After about 1073 K and up to about 1273 K, the thermal diffusivity values for the composite samples rose above the values for the 15 wt % SPS sample. The thermal diffusivity values for the 5 wt % UB₂ SPS sample were about 3.4 mm²/sec at about 300 K and about 0.5 mm²/sec at about 1173 K. Without being bound by theory, the increase in thermal diffusivity for the composite samples over the reported 5 wt % UB₂ SPS and 15 wt % UB₂ SPS samples was believed to be due to the lack of the UB₄ phase in the composite samples.

The heat capacity, or specific heat values, Cₚ, for the 4-hr samples from composite fuel structures were about 0.28 J/g-K at about 300 K and about 0.37 J/g-K at about 1273 K. The heat capacity, or specific heat values, Cₚ, for the 8-hr samples from composite fuel structures were about 0.28 J/g-K at about 300 K and about 0.43 J/g-K at about 1273 K. The heat capacity, or specific heat values, Cₚ, for the pure UB₂ samples, or literature values, were about 0.22 J/g-K at about 300 K and about 0.35 J/g-K at about 1273 K. The heat capacity, or specific heat values, Cₚ, for the pure UO₂ samples, or literature values, were about 0.23 J/g-K at about 300 K and about 0.31 J/g-K at about 1273 K. The heat capacity, or specific heat values, Cₚ, for the ROM samples were about 0.23 J/g-K at about 300 K and about 0.32 J/g-K at about 1273 K. At least until temperatures reached about 575° C. (848 K), the 4-hr and 8-hr measured heat capacity values were within the reported error of each other (i.e., error bars represented one standard deviation). Above 575° C. (848 K), the heat capacity values for the 8-hr sample continued to rise with temperature to 0.43 J/g·K, while the values for the 4-hr sample tapered off to an average value of 0.37 J/g·K. The 8-hr fuel structure trends were similar to the pure UB₂ sample, while the 4-hr fuel structure trends were more similar to the pure UO₂. Without being bound by theory, the differences in the heat capacity values above 848 K may have been due to issues with the instrument sensitivity or possibly oxidation of the samples at the elevated temperature.

### Example 4: Density Calculations of Some Embodiments

In some embodiments, the density of the fuel structures discussed above may be measured relative to a quantity of fissile material remaining after a final heat transfer process. In this example, a first fuel structure including UO₂ and UB₂, used about four (4) wt % of fissile additive and resulted in a five (5) gram fuel structure comprising about 4.415 grams of uranium after sintering (e.g., 88.3% uranium or more in total material composition). A second fuel structure, comprising a UO₂+(Gd₂O3/Er₂O₃), five (5) gram pellet, resulted in 4.231 grams of uranium after sintering (e.g., 84.62% uranium). The increase in uranium density of the composite fuel structure, prepared according to the methods of this disclosure, relative to the UO₂+(Gd₂O3/Er₂O₃) indicated potential for increased fuel loading while maintaining beneficial IBA properties, due to the presence of the boron in the composite fuel structures.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A fuel structure, comprising:
an advanced technology fuel (ATF) composite body comprising:
a first fissile material comprising uranium oxide (UO₂);
a second fissile material comprising uranium diboride (UB₂), boron atoms of the second fissile material comprising an integrated burnable absorber (IBA); and
an ATF composition comprising the second fissile material combined with the first fissile material, the IBA of the second fissile material distributed in a matrix of the first fissile material without a detectable amount of uranium tetraboride (UB₄).

2. The fuel structure of claim 1, wherein the ATF composite body comprises about 90 wt % UO₂, about 10 wt % UB₂, and greater than about 88% uranium density in total material composition.

3. The fuel structure of claim 1, further comprising one or more additives.

4. The fuel structure of claim 3, wherein the one or more additives comprise a fission barrier material comprising zirconium.

5. The fuel structure of claim 1, wherein the IBA is uniformly distributed in the first fissile material.

6. The fuel structure of claim 1, wherein an average grain size of the UB₂ ranges from about 0.5 microns to about 3.5 microns.

7. The fuel structure of claim 1, wherein the second fissile material is distributed in a matrix of the first fissile material without a detectable amount of dodecaboride (UB₁₂).

8. The fuel structure of claim 1, wherein the fuel structure is configured as a right cylindrical shape.

9. A fuel rod assembly, comprising:
a pressurized housing;
an array of fuel structures within the pressurized housing;
cladding material between the array of fuel structures and the pressurized housing, wherein one or more fuel structures of the array of fuel structures comprises:
an advanced technology fuel (ATF) composite body comprising:
a first fissile material and a second fissile material, the second fissile material comprising uranium atoms and boron atoms; and
one or more additives distributed with the second fissile material throughout a matrix of the first fissile material; and
wherein the ATF composite body does not have a detectable UB₄ phase.

10. The fuel rod assembly of claim 9, wherein the second fissile material comprises a non-stoichiometric amount of boron atoms relative to an amount of the uranium atoms in the second fissile material.

11. The fuel rod assembly of claim 9, wherein the second fissile material comprises uranium diboride (UB₂).

12. The fuel rod assembly of claim 9, wherein one or more fuel structures of the array of fuel structures have less than or equal to about 90 wt %:10 wt % UO₂:UB₂, and at least one fuel structure of the array of fuel structures has no IBA.

13. The fuel rod assembly of claim 12, wherein the one or more fuel structures having less than or equal to about 90 wt %:10 wt % UO₂:UB₂ and the at least one fuel structure of the array of fuel structures having no IBA comprise an arrangement of fuel structures that creates a gradient distribution of IBA along a height of the pressurized housing.

14. A method of forming a fuel structure, the method comprising:
selecting a first fissile material comprising uranium oxide;
selecting a second fissile material comprising uranium boride, boron atoms of the second fissile material comprising an integrated burnable absorber (IBA), the boron atoms combined with uranium atoms comprising an initial IBA composition;
adjusting an amount of the boron atoms of the initial IBA composition to form a second IBA composition;
forming a preliminary fuel structure from the second IBA composition;
combining the first fissile material and the second fissile material, forming an advanced technology fuel (ATF) composition; and
applying heat through one or more heat transfer processes to the ATF composition to obtain a nuclear fuel structure having an IBA distributed throughout a crystalline matrix of the first fissile material without a detectable amount of uranium tetraboride (UB₄).

15. The method of claim 14, wherein adjusting an amount of the boron atoms of the initial IBA composition to form a second IBA composition comprises increasing boron of the initial IBA composition by about 0.01 wt %.

16. The method of claim 15, wherein forming a preliminary fuel structure from the second IBA composition comprises arc-melting the second IBA composition to form the preliminary fuel structure, and wherein the adjusting an amount of the boron atoms of the initial IBA composition to form a second IBA composition occurs prior to the arc-melting.

17. The method of claim 14, wherein combining the first fissile material and the second fissile material, forming an ATF composition comprises combining a deconstructed form of the preliminary fuel structure with the first fissile material.

18. The method of claim 14, wherein selecting a second fissile material comprising uranium boride further comprises:
selectively tailoring the second fissile material to include an enriched form of uranium diboride comprising a higher percentage of ¹¹B isotope or ¹⁰B isotope than a natural, elemental form of boron.

19. The method of claim 14, wherein applying heat through one or more heat transfer processes to the ATF composition to obtain a nuclear fuel structure having an IBA distributed throughout a crystalline matrix of the first fissile material without a detectable amount of UB₄ comprises sintering for at least four hours, at about 1800° C., and within an inert atmosphere.

20. The method of claim 19, wherein the sintering occurs for about eight hours and the inert atmosphere comprises an argon gas atmosphere.
